(19) United States
(12) Patent Application Publication
(10) Pub. No.: US 2026/0300462 A1
(43) Pub. Date: Oct. 1, 2026

(54) SCREEN UNLOCKING METHOD, ELECTRONIC DEVICE AND COMPUTER-READABLE STORAGE MEDIUM

(71) Applicant: GUANGDONG OPPO MOBILE TELECOMMUNICATIONS CORP., LTD., Dongguan (CN)

(72) Inventor: Hua GUO, Dongguan (CN)

(21) Appl. No.: 19/343,337

(22) Filed: Sep. 29, 2025

Related U.S. Application Data
(63) Continuation of application No. PCT/CN2024/084286, filed on Mar. 28, 2024.

(30) Foreign Application Priority Data
Mar. 29, 2023 (CN) 202310326511.1

(51) Int. Cl. G06F 21/36

(52) U.S. Cl. CPC G06F 21/36

(57) ABSTRACT

Provided are a screen unlocking method, an electronic device and a non-transitory computer-readable storage medium. In the screen unlocking method, when an electronic device is in a screen-locked state, in response to unlocking information input through an unlocking operation, a first operating system of the electronic device performs validity verification on the unlocking information when. When the validity verification performed on the unlocking information by the first operating system is passed, the unlocking information is sent to a second operating system of the electronic device. After correctness verification performed on the unlocking information by the second operating system is passed, the screen of the electronic device is unlocked.

### CROSS-REFERENCE OF RELATED APPLICATION

This application is a continuation of International Application No. PCT/CN2024/084286 filed on Mar. 28, 2024, which claims priority to Chinese Patent Application No. 202310326511.1 filed on Mar. 29, 2023, and the entire contents of which are incorporated herein by reference.

### TECHNICAL FIELD

The present disclosure relates to the field of computer technology, and particularly to a screen unlocking method, an electronic device, and a computer-readable storage medium.

### BACKGROUND

With the development of computer technology, more and more electronic devices operate with multiple operating systems. The coordinated operation of multiple operating systems can improve the performance of electronic devices.

### SUMMARY

Embodiments of the present disclosure provide a screen unlocking method, an electronic device, and a computer-readable storage medium.

In a first aspect, the embodiments of the present disclosure provide a screen unlocking method. The screen unlocking method is implemented by an electronic device capable of running a first operating system and a second operating system. The method includes:
in a case where the electronic device is in a screen-locked state, in response to unlocking information input through an unlocking operation, performing, by the first operating system, validity verification on the unlocking information;
after determining that the validity verification performed on the unlocking information by the first operating system is passed, sending, by the first operating system, the unlocking information to the second operating system; and
after correctness verification performed on the unlocking information by the second operating system is passed, unlocking a screen of the electronic device.

In a second aspect, the embodiments of the present disclosure further provide an electronic device. The electronic device includes a memory and one or more processors. The electronic device is capable of running at least a first operating system and a second operating system. The memory stores a computer program which, when being executed by the one or more processors causes the following operations to be implemented:
in a case where the electronic device is in a screen-locked state, upon receiving unlocking information input through an unlocking operation, performing, by the first operating system, validity verification on the unlocking information;
after determining that the validity verification performed on the unlocking information by the first operating system is passed, sending, by the first operating system, the unlocking information to the second operating system; and
after correctness verification performed on the unlocking information by the second operating system is passed, unlocking a screen of the electronic device.

In a third aspect, the embodiments of the present disclosure further provide a non-transitory computer-readable storage medium storing a computer program thereon. The computer program is executable by one or more processors of an electronic device. The electronic device is capable of running at least a first operating system and a second operating system. The computer program, when being executed by the one or more processors, causes the following operations to be implemented:
in a case where the electronic device is in a screen-locked state, after receiving unlocking information input through an unlocking operation, performing, by the first operating system, validity verification on the unlocking information;
after determining that the validity verification performed on the unlocking information by the first operating system is passed, sending, by the first operating system, the unlocking information to the second operating system; and
after correctness verification performed on the unlocking information by the second operating system is passed, unlocking a screen of the electronic device.

### BRIEF DESCRIPTION OF THE DRAWINGS

To more clearly illustrate technical solutions in the embodiments of the present disclosure or the prior art, drawings used for describing the embodiments or the prior art are briefly introduced below. Apparently, the drawings in the following description are only some embodiments of the present disclosure. For those of ordinary skill in the art, other drawings can be obtained based on these drawings without creative work.

FIG. 1 is a flow chart of a screen unlocking method according to an embodiment of the present disclosure.

FIG. 2 illustrates a hardware architecture of an electronic device according to an embodiment of the present disclosure.

FIG. 3 is a flow chart of a screen unlocking method according to another embodiment of the present disclosure.

FIG. 4 schematically illustrates interface changes during screen unlocking according to another embodiment of the present disclosure.

FIG. 5 is a flow chart of a screen unlocking method according to a further embodiment of the present disclosure.

FIG. 6 is a flow chart of a screen unlocking method according to yet a further embodiment of the present disclosure.

FIG. 7 is a flow chart of generating a target key according to an embodiment of the present disclosure.

FIG. 8 illustrates a software architecture of the electronic device according to an embodiment of the present disclosure.

FIG. 9 is a sequence diagram of a screen unlocking method according to an embodiment of the present disclosure.

FIG. 10 is a structural block diagram of a screen unlocking apparatus according to an embodiment of the present disclosure.

FIG. 11 is an internal structural diagram of the electronic device according to an embodiment of the present disclosure.

### DETAILED DESCRIPTION OF PREFERRED EMBODIMENTS

In order to make the purpose, technical solutions, and advantages of the present disclosure more clearly, the present disclosure will be further described in detail below in conjunction with the drawings and embodiments. It is understandable that the described embodiments herein are only used to explain the present disclosure, and should not be regarded as limiting the present disclosure.

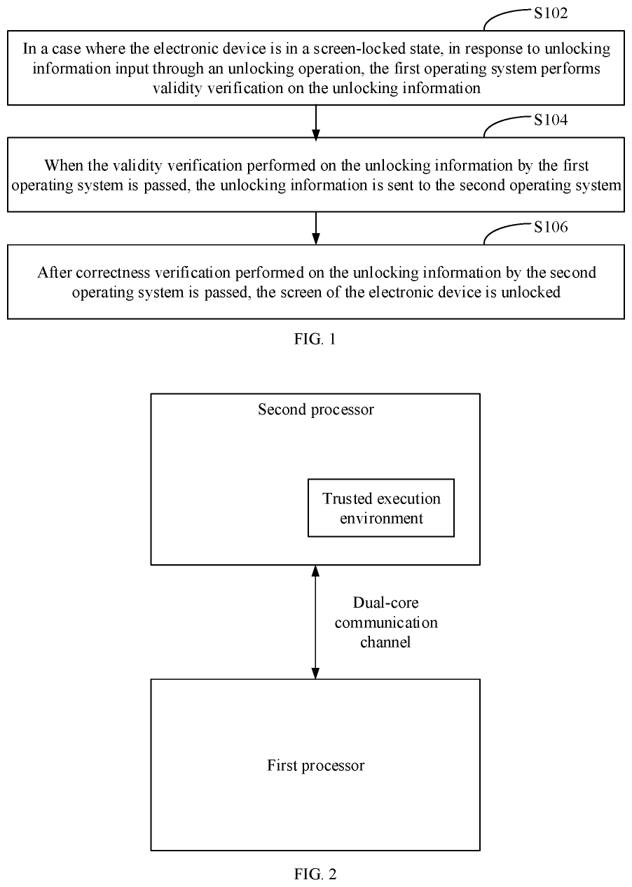

In an embodiment, as illustrated in FIG. 1, a screen unlocking method is provided. This embodiment is illustrated by taking case where the method is applied to an electronic device as an example. The electronic device may be a terminal. It is understandable that, the method may also be applied to a system including a terminal and a server, and implemented through interaction between the terminal and the server. The terminal may be, but not limited to, various personal computers, laptops, smartphones, tablets, Internet of Things (IOT) devices, and portable wearable devices. IoT devices may be smart speakers, smart TVs, smart air conditioners, smart in-vehicle devices, smart cars, and the like. Portable wearable devices may be smart watches, smart bracelets, head-mounted devices, and the like. The server may be implemented by an independent server or a server cluster composed of multiple servers.

In this embodiment, the screen unlocking method is applied to an electronic device. The electronic device includes a first processor and a second processor. The first processor runs a first operating system, and the second processor runs a second operating system. The power consumption of the first operating system is lower than that of the second operating system. The screen unlocking method includes operations S102 to S106.

In operation S102, in a case where the electronic device is in a screen-locked state, in response to unlocking information input through an unlocking operation, the first operating system performs validity verification on the unlocking information.

An operating system (OS) is a set of interrelated system software programs that manage and control computer operations, utilize and operate hardware and software resources, and provide public services to organize user interactions.

In the embodiments of the present disclosure, the electronic device includes the first processor and the second processor. The first processor and the second processor may be different processors, or different processing cores of a same processor.

It is understandable that the first operating system is executed by the first processor to implement functions of the first operating system, and the second operating system is executed by the second processor to implement functions of the second operating system.

FIG. 2 illustrates a hardware architecture of an electronic device according to an embodiment of present disclosure. The electronic device includes a first processor and a second processor. The first processor runs a first operating system, and the second processor runs a second operating system. The second operating system further includes a trusted execution environment (TEE). The first processor and the second processor communicate with each other through a dual-core communication channel.

The trusted execution environment is a secure area constructed by hardware and software means on a computing platform, which can ensure that the codes and data loaded in the secure area are protected in terms of confidentiality and integrity.

For example, the first processor is an Apollo4 processor, the second processor is an SDW5100 processor, the power consumption of the first processor is lower than that of the second processor, and the dual-core communication channel is a serial peripheral interface (SPI).

It is understandable that, in a certain operation mode or state of the electronic device, both the first operating system and the second operating system may be in a running state. Further, in this case, the first operating system runs in foreground, and the second operating system runs in background.

The power consumption of the first operating system is lower than that of the second operating system, that is, the first operating system is a power-saving type operating system, and the second operating system is a high-performance type operating system. In some implementations, the first operating system may be equipped with applications with low power consumption requirements, and the second operating system may be equipped with applications with high performance requirements.

In some implementations, the screen-locked state of the electronic device may be a screen-locked state when the screen is on, or a screen-locked state when the screen is off.

The unlocking operation is an operation used to unlock the screen. In some implementations, the unlocking operation may be an operation of clicking a number key(s) on the screen, a touch operation on an unlock key, a long-pressing operation on the screen, a double-clicking operation on the screen, etc., which is not limited herein. The unlocking information may be string information, biological information, a slide pattern (i.e., unlock pattern, pattern unlock, graphic pattern, or swipe graphic), or the like. The biological information may be fingerprint information, palm print information, iris information, or the like, which is not limited herein. The string information may be at least one of numbers, letters, or symbols.

Exemplarily, in the case where the electronic device is in the screen-locked state, in response to string information input by clicking the number key(s) on the screen, the first operating system performs the validity verification on the string information.

Exemplarily, in the case where the electronic device is in the screen-locked state, in response to fingerprint information input by touching the unlock key, the first operating system performs the validity verification on the fingerprint information.

Exemplarily, in the case where the electronic device is in the screen-locked state, in response to fingerprint information input by long-pressing the screen, the first operating system performs the validity verification on the fingerprint information.

It is understandable that the unlocking information is specific information used to unlock the screen, for example valid information for unlocking, such as biological information, a slide pattern, or string information of a preset length, and it cannot be invalid information such as non-biological information (e.g., information generated by accidental touch of clothes), information that does not define a slide pattern, or string information not having the preset length. The validity verification is used to determine whether the unlocking information complies with validity rules.

In some implementations, in a case where the first operating system of the electronic device controls the screen and the electronic device is in the screen-locked state, in response to an unlocking operation, the first operating system obtains the unlocking information input through the unlocking operation, and performs the validity verification on the unlocking information.

In some implementations, the performing the validity verification on the unlocking information by the first operating system includes: verifying whether the unlocking information is biological information, a slide pattern, or string information of a preset length; if the unlocking information is biological information, a slide pattern, or string information of a preset length, the validity verification performed on the unlocking information by the first operating system is passed; and if the unlocking information is not biological information, a slide pattern or string information of a preset length, the validity verification performed on the unlocking information by the first operating system is failed.

In operation S104, when the validity verification performed on the unlocking information by the first operating system is passed, the unlocking information is sent to the second operating system.

In some implementations, if the validity verification performed on the unlocking information by the first operating system is passed, the first operating system sends the unlocking information to the second operating system through the dual-core communication channel between the first operating system and the second operating system.

In some implementations, if the validity verification performed on the unlocking information by the first operating system is passed, the first operating system obtains encrypted unlocking information by encrypting the unlocking information, and sends the encrypted unlocking information to the second operating system through the dual-core communication channel between the first operating system and the second operating system. The second operating system receives the encrypted unlocking information, obtains the unlocking information by decrypting the encrypted unlocking information, and then performs the correctness verification on the unlocking information.

The first operating system uses a target key to encrypt the unlocking information, thereby obtaining the encrypted unlocking information. The second operating system uses the target key to decrypt the encrypted unlocking information, thereby obtaining the unlocking information. The target key is obtained after successful negotiation between the first operating system and the second operating system.

In operation S106, after correctness verification performed on the unlocking information by the second operating system is passed, the screen of the electronic device is unlocked.

In some implementations, the second operating system receives the unlocking information sent by the first operating system through the dual-core communication channel, and performs the correctness verification on the unlocking information. After the correctness verification of the unlocking information is passed, the screen of the electronic device is unlocked.

In some implementations, the second operating system has a trusted execution environment. The second operating system receives the unlocking information sent by the first operating system through the dual-core communication channel, and performs the correctness verification on the unlocking information in the trusted execution environment. After the correctness verification of the unlocking information is passed, the screen of the electronic device is unlocked.

It is understandable that the correctness verification is used to determine whether the unlocking information is the reference unlocking information preset by the user.

In some implementations, the second operating system stores the reference unlocking information preset by the user. The second operating system matches the unlocking information with the preset reference unlocking information. If the unlocking information matches the preset reference unlocking information, the correctness verification performed on the unlocking information by the second operating system is passed. If the unlocking information does not match the preset reference unlocking information, the correctness verification performed on the unlocking information by the second operating system is failed.

In some implementations, after the correctness verification performed on the unlocking information by the second operating system is passed, the screen of the electronic device is unlocked through the first operating system. In some implementations, after the correctness verification performed on the unlocking information by the second operating system is passed, the screen of the electronic device is unlocked through the second operating system.

It is understandable that either the first operating system or the second operating system may control the screen to unlock. Therefore, after the correctness verification of the unlocking information is passed, the screen of the electronic device may be unlocked through the first operating system or the second operating system.

In some implementations, after the screen of the electronic device is unlocked, the operating system that unlocks the screen runs in the foreground. For example, after the first operating system unlocks the screen of the electronic device, the first operating system runs in the foreground; alternatively, after the second operating system unlocks the screen of the electronic device, the second operating system runs in the foreground.

In some implementations, after the screen of the electronic device is unlocked, the operating system that ran in the foreground before the last screen lock now run in the foreground. For example, if the first operating system ran in the foreground before the last screen lock, after the screen of the electronic device is currently unlocked, the first operating system runs in the foreground; alternatively, if the second operating system ran in the foreground before the last screen lock, after the screen of the electronic device is currently unlocked, the second operating system runs in the foreground.

Traditional screen unlocking methods require frequent wake-up of the system for screen unlocking, resulting in high power consumption of the device. In the above screen unlocking method, the electronic device includes a first processor and a second processor. The first processor runs a first operating system, and the second processor runs a second operating system. The power consumption of the first operating system is lower than that of the second operating system. In a case where the electronic device is in the screen-locked state, in response to unlocking information input through an unlocking operation, the first operating system with lower power consumption performs validity verification on the unlocking information, and sends the unlocking information to the second operating system when the validity verification is passed. This can avoid the second operating system with higher power consumption from performing correctness verification upon each input of the unlocking information, and also avoid the second operating system with higher power consumption from directly performing verification on input incorrect unlocking information, and it reduces the power consumption required for the validity verification of the unlocking information. Furthermore, after the correctness verification performed on the unlocking information by the second operating system is passed, the screen of the electronic device is unlocked, which reduces the power consumption required in the entire screen unlocking process.

In an embodiment, with regard to the operation that the first operating system performs, in response to unlocking information input through the unlocking operation, the validity verification on the unlocking information in the case where the electronic device is in the screen-locked state, it includes: in the case where the electronic device is in the screen-locked state, the first operating system displays a screen-locked interface; and in response to unlocking information input through an unlocking operation triggered on the screen-locked interface, the first operating system performs the validity verification on the unlocking information.

The screen-locked interface (i.e., LockView) is an interface displayed when the screen is in a screen-locked state. The screen-locked interface may display a dial or an unlock prompt element, and may also display time information, weather information, wallpaper patterns, etc., which is not limited herein. The unlock prompt element may be text(s), a fingerprint pattern, or an iris pattern used for unlock prompts.

In some implementations, in a case where the screen is controlled by the first operating system when the screen of the electronic device is off, the first operating system determines whether the screen is in the screen-locked state, in response to a screen-on operation. If the first operating system determines that the screen is in the screen-locked state, the screen-locked interface is displayed. If the first operating system determines that the screen is not in the screen-locked state, an interface before the last screen-off is displayed.

Exemplarily, in a case where the screen is controlled by the first operating system when the screen of the electronic device is off, the first operating system determines whether the screen is in the screen-locked state, in response to the user's wrist-lifting operation that triggers the screen to be on. If the first operating system determines that the screen is in the screen-locked state, the screen-locked interface (i.e., Lock View interface) is displayed.

For example, a fingerprint pattern for unlock prompt is displayed on the screen-locked interface. In response to fingerprint information input by pressing the fingerprint pattern on the screen-locked interface, the first operating system performs the validity verification on the fingerprint information.

In this embodiment, when the electronic device is in the screen-locked state, the first operating system with lower power consumption displays an operable screen-locked interface, and the first operating system performs the validity verification on the input unlocking information. This can reduce the power consumption for displaying the screen-locked interface and the power consumption for validity verification, thereby reducing the power consumption in the screen unlocking process.

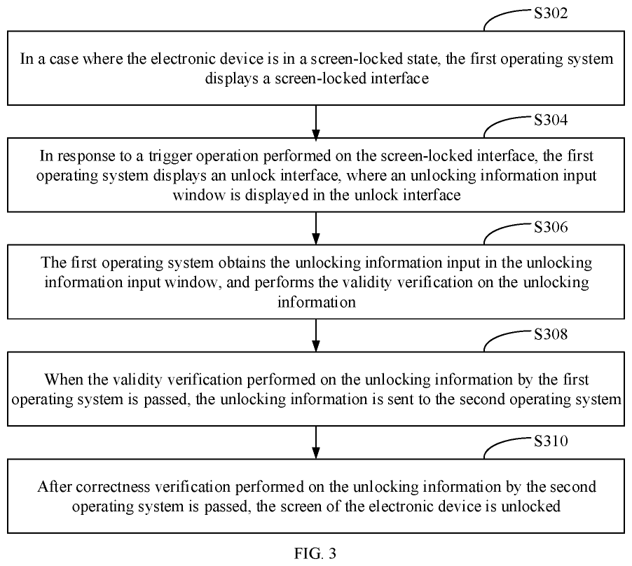

In an embodiment, as illustrated in FIG. 3, another screen unlocking method is provided, which is applied to an electronic device. The electronic device includes a first processor and a second processor. The first processor runs a first operating system, and the second processor runs a second operating system. The power consumption of the first operating system is lower than that of the second operating system. The screen unlocking method includes operations S302 to S310.

In operation S302, in a case where the electronic device is in a screen-locked state, the first operating system displays a screen-locked interface.

In operation S304, in response to a trigger operation performed on the screen-locked interface, the first operating system displays an unlock interface, where an unlocking information input window is displayed in the unlock interface.

It is understandable that there are multiple ways to unlock the screen. The unlocking information may be input by triggering an unlocking operation on the screen-locked interface, or the unlock interface (i.e., Unlock View) may be entered after the screen-locked interface is triggered, and the unlocking information may be input in the unlocking information input window of the unlock interface, or other ways may be used, which is not limited herein.

For example, fingerprint information may be input by pressing the fingerprint pattern for unlock prompt on the screen-locked interface, and the input fingerprint information is used to unlock the screen. For another example, a double-click operation or a sliding operation is performed on the screen-locked interface, and the unlock interface is entered; then, string information is input in the unlocking information input window of the unlock interface, and the input string information is used to unlock the screen.

The unlocking information input window is a window configured to input unlocking information. Number keys, letter keys, or a matrix of dots may be displayed in the unlocking information input window. The user may input number information by clicking the number key(s), input letter information by clicking the letter key(s), and define a slide pattern by performing a sliding operation on the matrix of dots.

In operation S306, the first operating system obtains the unlocking information input in the unlocking information input window, and performs the validity verification on the unlocking information.

In some implementations, after the input of the unlocking information is completed, the first operating system obtains the unlocking information input in the unlocking information input window and performs the validity verification on the unlocking information.

For example, a 4-digit password is input in the unlocking information input window, indicating that the input of the unlocking information is completed. Then, the first operating system obtains the 4-digit password and performs the validity verification on the 4-digit password.

In operation S308, when the validity verification performed on the unlocking information by the first operating system is passed, the unlocking information is sent to the second operating system.

In operation S310, after correctness verification performed on the unlocking information by the second operating system is passed, the screen of the electronic device is unlocked.

In this embodiment, the electronic device includes a first processor and a second processor. The first processor runs a first operating system, and the second processor runs a second operating system. The power consumption of the first operating system is lower than that of the second operating system. In a case where the electronic device is in the screen-locked state, the first operating system with lower power consumption displays a screen-locked interface. In response to an unlocking operation triggered on the screen-locked interface, an unlock interface is entered. The first operating system obtains the unlocking information input in the unlocking information input window of the unlock interface, performs the validity verification on the unlocking information, and sends the unlocking information to the second operating system when the validity verification is passed. This can avoid the second operating system with higher power consumption from performing the correctness verification upon each input of the unlocking information, and also avoid the second operating system with higher power consumption from directly performing verification on input incorrect unlocking information, and it reduces the power consumption required for the validity verification of the unlocking information. Furthermore, after the correctness verification performed on the unlocking information by the second operating system is passed, the screen of the electronic device is unlocked, which reduces the power consumption required in the entire screen unlocking process.

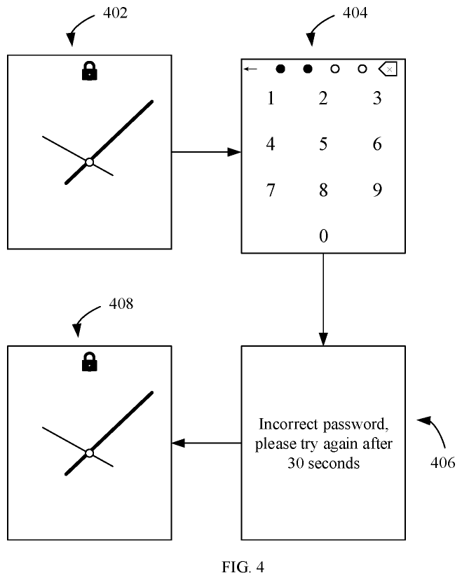

In an embodiment, as illustrated in FIG. 4, in a case where the electronic device is in the screen-locked state, the first operating system displays a screen-locked interface 402, and a dial and a screen-locked mark are displayed on the screen-locked interface 402. If the user touches any position or any button on the screen-locked interface 402, the first operating system displays an unlock interface 404 in response to the user's touch trigger operation on the screen-locked interface 402. A digital password input window is displayed on the unlock interface 404. After the user inputs 4-digit digital information, the first operating system performs the validity verification on the input digital information. If the validity verification performed on the digital information by the first operating system is passed, the digital information is sent to the second operating system. If the correctness verification performed on the digital information by the second operating system is failed, first prompt information is displayed on the unlock interface, where the first prompt information may be that the 4-digit digital information input in the digital password input window shakes and falls, and the 4-digit digital information is eliminated or hidden.

If the verification of the unlocking information by the first operating system or the second operating system is failed, the first operating system locks the unlock interface for a preset time period, such that no unlocking information can be input in the unlock interface within the preset time period. The preset time period may be set as required, for example, 30 seconds(s).

The first operating system counts the number of failed verifications of the unlocking information for the current round of unlocking. If the number of failed verifications of the unlocking information for the current round of unlocking reaches a first preset number threshold, a prompt interface 406 is displayed. Second prompt information is displayed on the prompt interface 406, and the prompt interface is locked for a preset time period. The second prompt information may be “Incorrect password, please try again after 30 seconds”.

The first preset number threshold and the preset time period may be set as required. For example, the preset number threshold is 5, and the preset time period is 30 seconds(s).

The first operating system counts the number of rounds in which the prompt interface is locked. If the number of rounds in which the prompt interface is locked reaches a second preset number threshold, the prompt interface is locked for a preset time period each time the verification of the unlocking information is failed, and second prompt information is displayed. The prompt information includes a time control of the preset time period, and the time control is controlled to display a countdown of the preset time period. It is understandable that, if the prompt interface is locked for the preset time period, the electronic device cannot be operated within the locked preset time period.

If the verification of the unlocking information by the first operating system or the second operating system is failed, a return button may be triggered, and the first operating system displays a screen-locked interface 408, where a dial and a screen-locked mark are displayed on the screen-locked interface 408.

In some implementations, the electronic device is bound to other devices, and the other devices store reference unlocking information used to unlock the screen of the electronic device. If the binding relationship between the other devices and the electronic device is removed, and the reference unlocking information stored in the other devices is cleared, the electronic device no longer sets a screen-locked interface.

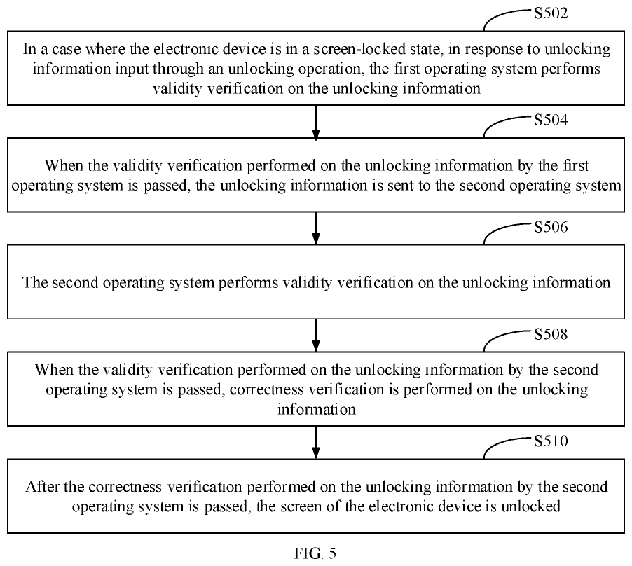

In an embodiment, as illustrated in FIG. 5, a further screen unlocking method is provided, which is applied to an electronic device. The electronic device includes a first processor and a second processor. The first processor runs a first operating system, and the second processor runs a second operating system. The power consumption of the first operating system is lower than that of the second operating system. The screen unlocking method includes operations S502 to S510.

In operation S502, in a case where the electronic device is in a screen-locked state, in response to unlocking information input through an unlocking operation, the first operating system performs validity verification on the unlocking information.

In operation S504, when the validity verification performed on the unlocking information by the first operating system is passed, the unlocking information is sent to the second operating system.

In operation S506, the second operating system performs validity verification on the unlocking information.

In some implementations, the second operating system receives the unlocking information sent by the first operating system through the dual-core communication channel, and performs the validity verification on the unlocking information. This can avoid problems such as tampering of the unlocking information during transmission, and improve the accuracy of the verification of the unlocking information by the second operating system.

In operation S508, when the validity verification performed on the unlocking information by the second operating system is passed, correctness verification is performed on the unlocking information.

In some implementations, with regard to the operation that the second operating system performs the validity verification on the unlocking information, it includes: verifying whether the unlocking information is biological information, a slide pattern, or string information of a preset length; if the unlocking information is biological information, a slide pattern, or string information of a preset length, the validity verification performed on the unlocking information by the second operating system is passed; and if the unlocking information is not biological information, a slide pattern or string information of a preset length, the validity verification performed on the unlocking information by the second operating system is failed.

In some implementations, the second operating system has a trusted execution environment. The operation of performing correctness verification on the unlocking information when the validity verification performed on the unlocking information by the second operating system is passed, includes: when the validity verification performed on the unlocking information by the second operating system is passed, performing the correctness verification on the unlocking information in the trusted execution environment.

It is understandable that the second operating system has a trusted execution environment, and the performing the correctness verification in the trusted execution environment of the second operating system can improve the security of the correctness verification of the unlocking information.

In operation S510, after the correctness verification performed on the unlocking information by the second operating system is passed, the screen of the electronic device is unlocked.

In this embodiment, after receiving the unlocking information, the second operating system first performs the validity verification on the unlocking information. Only the validity verification performed on the unlocking information by the second operating system is passed, the second operating system performs the correctness verification on the unlocking information. This can avoid the problem of tampering of the unlocking information during the transmission from the first operating system to the second operating system, and improve the accuracy of screen unlocking.

In another embodiment, another screen unlocking method is provided, which is applied to an electronic device. The electronic device includes a first processor and a second processor. The first processor runs a first operating system, and the second processor runs a second operating system. The power consumption of the first operating system is lower than that of the second operating system. The screen unlocking method includes operations as follows. In a case where the electronic device is in a screen-locked state, the first operating system displays a screen-locked interface. In response to unlocking information input through an unlocking operation triggered on the screen-locked interface, the first operating system performs validity verification on the unlocking information. When the validity verification performed on the unlocking information by the first operating system is passed, the unlocking information is sent to the second operating system. The second operating system performs validity verification on the unlocking information. When the validity verification performed on the unlocking information by the second operating system is passed, the second operating system performs correctness verification on the unlocking information. After the correctness verification performed on the unlocking information by the second operating system is passed, the screen of the electronic device is unlocked.

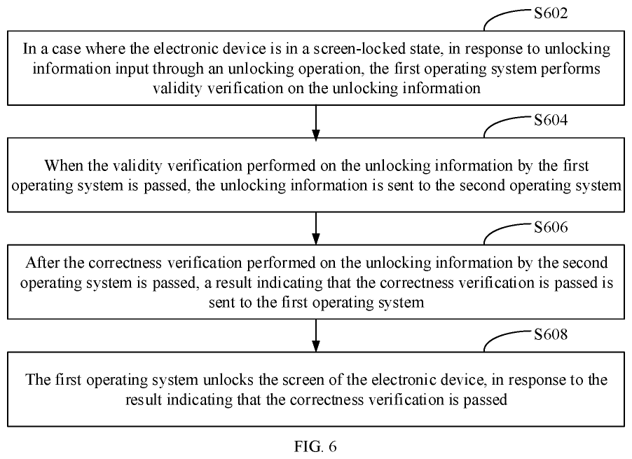

In an embodiment, as illustrated in FIG. 6, another screen unlocking method is provided, which is applied to an electronic device. The electronic device includes a first processor and a second processor. The first processor runs a first operating system, and the second processor runs a second operating system. The power consumption of the first operating system is lower than that of the second operating system. The screen unlocking method includes operations S602 to S608.

In operation S602, in a case where the electronic device is in a screen-locked state, in response to unlocking information input through an unlocking operation, the first operating system performs validity verification on the unlocking information.

In operation S604, when the validity verification performed on the unlocking information by the first operating system is passed, the unlocking information is sent to the second operating system.

In operation S606, after the correctness verification performed on the unlocking information by the second operating system is passed, a result indicating that the correctness verification is passed is sent to the first operating system.

In some implementations, the second operating system performs the correctness verification on the unlocking information, and sends the result indicating that the correctness verification is passed to the first operating system through the dual-core communication channel.

In some implementations, if the correctness verification performed on the unlocking information by the second operating system is passed, a result indicating that the correctness verification is passed is sent to the first operating system. If the correctness verification performed on the unlocking information by the second operating system is failed, a result indicating that the correctness verification is failed is sent to the first operating system.

In operation S608, the first operating system unlocks the screen of the electronic device, in response to the result indicating that the correctness verification is passed.

In some implementations, the first operating system receives the result indicating that the correctness verification is passed from the second operating system through the dual-core communication channel. If the first operating system determines that the correctness verification is passed, the screen of the electronic device is unlocked.

In some implementations, if the validity verification performed on the unlocking information by the second operating system is failed, a result indicating that the correctness verification is failed is sent to the first operating system. In response to the result indicating that the correctness verification is failed, the first operating system displays prompt information indicating the failed correctness verification.

For example, the prompt information indicating the failed correctness verification may be text information such as “Incorrect password”, or voice information, vibration, or other information presenting a shaking effect of the screen interface, which is not limited herein.

In this embodiment, after the correctness verification performed on the unlocking information by the second operating system is passed, the second operating system sends to the first operating system the result indicating that the correctness verification is passed, and the first operating system controls the screen to be unlocked, which can reduce the power consumption in the screen unlocking process.

In an embodiment, with regard to the operation that the result indicating the correctness verification is passed is sent to the first operating system when the correctness verification performed on the unlocking information by the second operating system is passed, it includes: after the correctness verification performed on the unlocking information by the second operating system is passed, encrypting the result indicating that the correctness verification is passed, and sending the encrypted result indicating that the correctness verification is passed to the first operating system. With regard to the operation that the first operating system unlocks the screen of the electronic device in response to the result indicating that the correctness verification is passed, it includes: decrypting, by the first operating system, the encrypted result indicating that the correctness verification is passed, and unlocking the screen of the electronic device in response to obtaining, through the decrypting, the result indicating that the correctness verification is passed.

In some implementations, after the correctness verification performed on the unlocking information by the second operating system is passed, the second operating system uses a target key to encrypt the result indicating that the correctness verification is passed to obtain the encrypted result indicating that the correctness verification is passed, and then sends the encrypted result indicating that the correctness verification is passed to the first operating system through the dual-core communication channel.

The first operating system receives the encrypted result indicating that the correctness verification is passed from the second operating system through the dual-core communication channel, uses the target key to decrypt the encrypted result indicating that the correctness verification is passed to obtain the result indicating that the passed correctness verification is passed, and unlocks the screen of the electronic device in response to obtaining, through the decrypting, the result indicating that the correctness verification is passed. The target key is obtained after successful negotiation between the first operating system and the second operating system.

In some implementations, the first operating system includes a LockService module, and the second operating system includes a SystemUI module. The LockService module in the first operating system and the SystemUI module in the second operating system use the Elliptic Curve Diffie-Hellman key Exchange (ECDH) algorithm to perform the negotiation, thereby obtaining the target key. The ECDH algorithm is a key negotiation algorithm that enables both communicating parties to exchange shared parameters over an insecure channel, thereby calculating a session key using the shared parameters and their own private parameters.

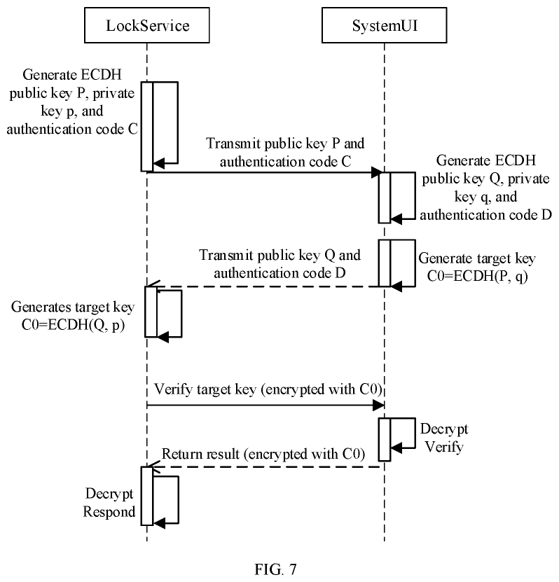

As illustrated in FIG. 7, the LockService module generates an ECDH public key P, a private key p, and an authentication code C, and transmits the public key P and the authentication code C to the SystemUI module. The SystemUI module generates an ECDH public key Q, a private key q, and an authentication code D, generates a target key C0=ECDH(P, q), saves the target key C0, and transmits the public key Q and the authentication code D to the LockService module. The LockService module generates a target key C0=ECDH(Q, p), and saves the target key C0. The LockService module sends an instruction for verifying the target key to the SystemUI module, and the instruction is encrypted with the target key C0. The SystemUI module uses the target key C0 to decrypt the instruction and perform the verification, and returns the verification result to the LockService module, where the result is encrypted with the target key C0. The LockService module uses the target key C0 to decrypt and respond to the result, thereby obtaining the target key. After the target key is obtained through negotiation, the data transmitted between the LockService module and the SystemUI module (the first operating system and the second operating system) is encrypted and decrypted by using the target key.

In this embodiment, the second operating system first encrypts the result indicating that the correctness verification is passed, then sends the encrypted result indicating that the correctness verification is passed to the first operating system. The first operating system may decrypt the encrypted result indicating that the correctness verification is passed, and then unlock the screen in response to obtaining, through the decrypting, the result indicating that the correctness verification is passed. This can improve the security of the transmission of the result indicating that the correctness verification is passed between the first operating system and the second operating system.

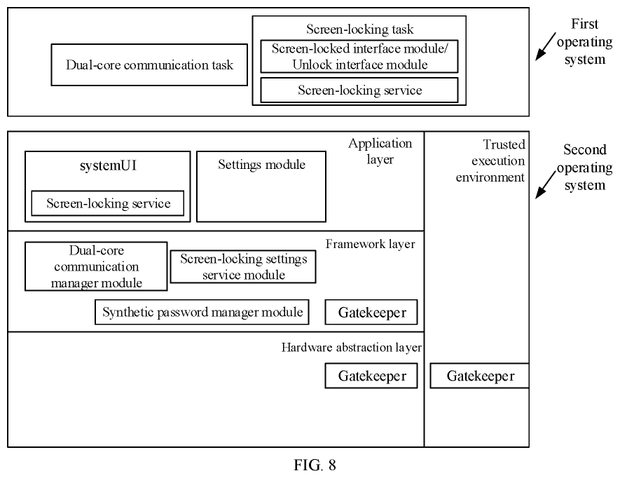

FIG. 8 illustrates a software architecture of an electronic device according to an embodiment. The electronic device includes a first operating system and a second operating system. The first operating system includes a screen-locking task (KeyguardTask) and a dual-core communication task (DualCoreCommunicationTask). The screen-locking task includes a screen-locked interface module (LockView)/unlock interface module (UnlockView), and a screen-locking service (McuLockService). The second operating system includes an application layer (Applications), a framework layer (Framework), a hardware abstraction layer (HAL), and a trusted execution environment. The application layer includes a settings module (Settings) and a systemUI. The systemUI includes a screen-locking service (MculockServicelmpl). The framework layer includes a dual-core communication manager module (DualCoreCommunicationManager), a screen-locking settings service module (LockSettingsService), a synthetic password manager module (SyntheticPasswordManager), and a gatekeeper. The hardware abstraction layer includes a gatekeeper. The trusted execution environment includes a gatekeeper.

The systemUI is used to implement the status bar, message center, recent tasks, screen capture, and a series of functions in the screen interface. The gatekeeper in the framework layer, the gatekeeper in the hardware abstraction layer, and the gatekeeper in the trusted execution environment of the second operating system are a same object. According to the layered design concept of Android, the gatekeeper undertakes different functions at different layers, that is, it provides interfaces upward from the trusted execution environment, the hardware abstraction layer, and the framework layer in sequence. The gatekeeper is a user identity verification program (used for PIN code/unlock pattern/password identity verification).

The settings module in the second operating system may be used to add, modify, or delete reference unlocking information.

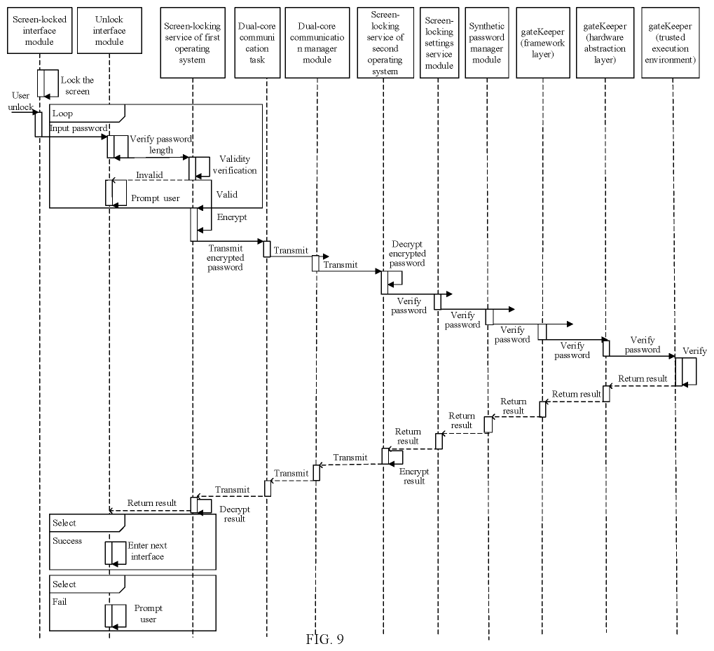

FIG. 9 illustrates a sequence diagram of a screen unlocking method according to an embodiment. The screen-locked interface module in the first operating system is configured to control the screen to enter a screen-locked state, display a screen-locked interface, and enter a loop process in response to a user's unlocking operation. The loop process includes operations as follows. The screen-locked interface module obtains the password input by the user, and sends the password to the unlock interface module. The unlock interface module verifies the password length, and sends the password to the screen-locking service of the first operating system after the password length verification is passed. The screen-locking service of the first operating system performs the validity verification on the password. If the validity verification is passed, that is, the password is valid, the password is encrypted, and the encrypted password is sent to the dual-core communication task. If the validity verification is failed, that is, the password is invalid, the unlock interface module displays prompt information to prompt the user.

The dual-core communication task in the first operating system transmits the encrypted password to the dual-core communication manager module in the second operating system, and the dual-core communication manager module transmits the encrypted password to the screen-locking service of the second operating system. The screen-locking service of the second operating system decrypts the encrypted password to obtain the decrypted password, initiates a password verification process, and calls the interface of the screen-locking settings service module in the framework layer to verify the password. The screen-locking settings service module calls the interface of the synthetic password manager module to verify the password. The synthetic password manager module calls the interface of the gatekeeper in the framework layer to verify the password. The gatekeeper in the framework layer calls the interface of the gatekeeper in the hardware abstraction layer to verify the password. The gatekeeper in the hardware abstraction layer calls the interface of the gatekeeper in the trusted execution environment, and the password is verified in the trusted execution environment to obtain a verification result.

The gatekeeper in the trusted execution environment returns the result to the gatekeeper in the hardware abstraction layer. The gatekeeper in the hardware abstraction layer returns the result to the gatekeeper in the framework layer. The gatekeeper in the framework layer returns the result to the synthetic password manager module. The password manager module returns the result to the screen-locking settings service module, and the screen-locking settings service module returns the result to the screen-locking service of the second operating system. The screen-locking service of the second operating system encrypts the result, and transmits it to the dual-core communication manager module. The dual-core communication manager module transmits the encrypted result to the dual-core communication task in the first operating system. The dual-core communication task in the first operating system transmits the encrypted result to the screen-locking service of the first operating system. The screen-locking service of the first operating system decrypts the encrypted result to obtain the decrypted result, and returns the decrypted result to the unlock interface module.

If the unlock interface module determines that the decrypted result indicates a successful verification, that is, the correctness verification is passed, the screen is unlocked and a next interface is entered. If the unlock interface module determines that the decrypted result indicates a failed verification, that is, the correctness verification is failed, the user is prompted.

It is understandable that the electronic device uses the first operating system with lower power consumption as the front-end window for user operations during screen locking or unlocking, and uses the second operating system with the trusted execution environment as the serving terminal for the correctness verification of the unlocking information. The first operating system and the second operating system work together, which can not only reduce the power consumption of screen unlocking, but also ensure the security of screen unlocking.

In an embodiment, the above method further includes: in a case where the screen is controlled by the second operating system, in response to the screen being turned off, controlling the screen by the first operating system; and upon determining that the screen meets a screen-locking condition, controlling, by the first operating system, the screen to enter the screen-locked state.

It is notable that, when the screen of the electronic device is turned off, the screen may or may not enter the screen-locked state.

It is understandable that, in the case where the screen is controlled by the second operating system, that is, when the second operating system runs in the foreground, if the screen is turned off, the operating system running in the foreground is switched to the first operating system from the second operating system, and the screen is controlled by the first operating system running in the foreground; and upon determining that the screen meets the screen-locking condition, the first operating system controls the screen to enter the screen-locked state.

The screen-locking condition may be set as required. The screen-locking condition may be that a duration during which the screen is off reaches a preset duration, or the electronic device is separated from the user, or the user triggers a screen-locking key, etc., which is not limited herein. The preset duration may be set as required, such as 5 seconds(s).

For example, the electronic device is a watch. After an unlock password is set in the watch, if the watch is separated from the user's wrist, the watch enters a screen-locked state. After the watch enters the screen-locked state, only the dial may be viewed on the screen-locked interface.

In this embodiment, in the case where the screen is controlled by the second operating system, if the screen is turned off, the screen is controlled by the first operating system with lower power consumption; and when the screen meets the screen-locking condition, the first operating system with lower power consumption controls the screen to enter a screen-locked state, which can reduce the power consumption of the electronic device after the screen is turned off.

In another embodiment, in the case where the screen is controlled by the second operating system, if the screen is turned off, the screen is still controlled by the second operating system; and if the second operating system determines that the screen meets the screen-locking condition, the second operating system controls the screen to enter the screen-locked state. In addition, in response to the screen being turned on, the operating system running in the foreground is switched to the first operating system from the second operating system, and the screen-locked interface is displayed by the first operating system.

In an embodiment, another screen unlocking method is provided, which is applied to an electronic device. The electronic device includes a first processor and a second processor. The first processor runs a first operating system, and the second processor runs a second operating system. The power consumption of the first operating system is lower than that of the second operating system. The screen unlocking method includes operations A1 to A10.
In operation A1, in a case where the electronic device is in a screen-locked state, the first operating system displays a screen-locked interface.
In operation A2, in response to a trigger operation performed on the screen-locked interface, the first operating system displays an unlock interface, where an unlocking information input window is displayed in the unlock interface.
In operation A3, the first operating system obtains unlocking information input in the unlocking information input window, and performs validity verification on the unlocking information.
In operation A4, when the validity verification performed on the unlocking information by the first operating system is passed, the unlocking information is sent to the second operating system.
In operation A5, the second operating system performs validity verification on the unlocking information.
In operation A6, the second operating system has a trusted execution environment, and when the validity verification performed on the unlocking information by the second operating system is passed, the correctness verification is performed on the unlocking information in the trusted execution environment.
In operation A7, after the correctness verification performed on the unlocking information by the second operating system is passed, a result indicating that the correctness verification is passed is encrypted, and the encrypted result indicating that the correctness verification is passed is sent to the first operating system.
In operation A8, the first operating system decrypts the encrypted result indicating that the correctness verification is passed, and unlocks the screen of the electronic device in response to obtaining, through the decrypting, the result indicating that the correctness verification is passed.
In operation A9, in a case where the screen is controlled by the second operating system, in response to the screen being turned off, the screen is controlled by the first operating system.
In operation A10, upon determining that the screen meets a screen-locking condition, the first operating system controls the screen to enter the screen-locked state.

It is understandable that, although the operations in the flowcharts involved in the above embodiments are displayed in sequence according to the arrows, these operations are not necessarily executed in sequence according to the order indicated by the arrows. Unless explicitly stated herein, the execution of these operations is not strictly limited in order, and these operations may be executed in other orders. Moreover, at least part of the operations in the flowcharts involved in the above embodiments may include multiple operations or multiple stages, and these operations or stages are not necessarily executed at the same time, but may be executed at different times. These operations or stages are not necessarily executed in sequence, but may be executed in turn or alternately with other operations or at least part of the operations or stages in other operations.

Based on the same inventive concept, the embodiments of the present disclosure further provide a screen unlocking apparatus for implementing the above-mentioned screen unlocking method(s). The solution for solving the problem provided by the apparatus is similar to the solution of the above methods. Therefore, for the specific limitations in one or more embodiments of the screen unlocking apparatus provided below, reference may be made to the definitions on the screen unlocking methods above, which will not be repeated here.

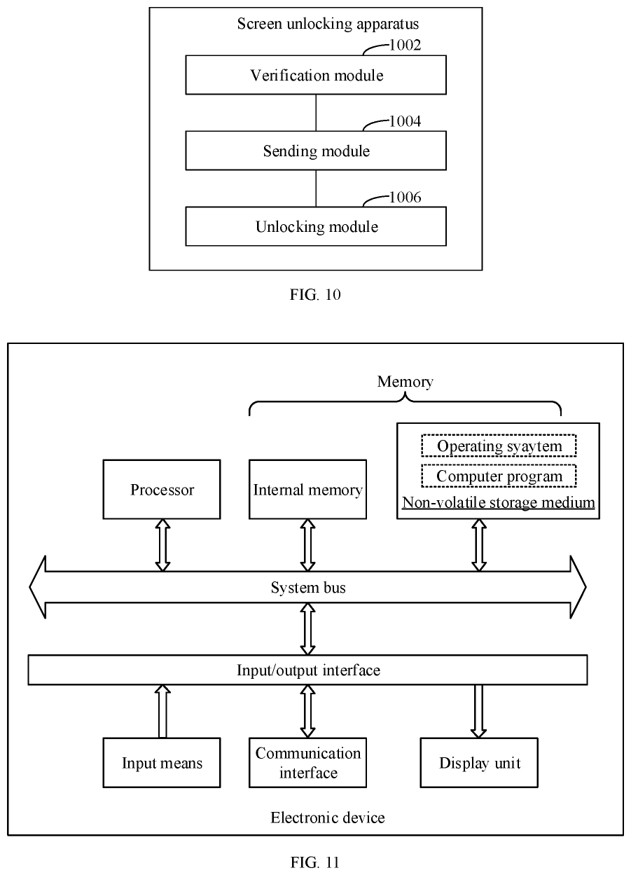

In an embodiment, as illustrated in FIG. 10, a screen unlocking apparatus is provided, which is implemented in an electronic device. The electronic device includes a first processor and a second processor. The first processor runs a first operating system, and the second processor runs a second operating system. The power consumption of the first operating system is lower than that of the second operating system. The apparatus includes a verification module 1002, a sending module 1004, and an unlocking module 1006.

The verification module 1002 is configured to, in a case where the electronic device is in a screen-locked state, in response to unlocking information input through an unlocking operation, cause the first operating system to perform validity verification on the unlocking information.

The sending module 1004 is configured to send the unlocking information to the second operating system, when the validity verification performed on the unlocking information by the first operating system is passed.

The unlocking module 1006 is configured to unlock the screen of the electronic device, after correctness verification performed on the unlocking information by the second operating system is passed.

In the above screen unlocking apparatus, the electronic device includes a first processor and a second processor. The first processor runs a first operating system, and the second processor runs a second operating system. The power consumption of the first operating system is lower than that of the second operating system. In a case where the electronic device is in a screen-locked state, in response to unlocking information input through an unlocking operation, the first operating system with lower power consumption performs the validity verification on the unlocking information, and sends the unlocking information to the second operating system when the validity verification is passed. This can avoid the second operating system with higher power consumption from performing correctness verification upon each input of the unlocking information, and also avoid the second operating system with higher power consumption from directly performing verification on input incorrect unlocking information, and it reduces the power consumption required for the validity verification of the unlocking information. Furthermore, after the correctness verification performed on the unlocking information by the second operating system is passed, the screen of the electronic device is unlocked, which reduces the power consumption required in the entire screen unlocking process.

In an embodiment, the verification module 1002 is further configured to, in the case where the electronic device is in the screen-locked state, cause the first operating system to display a screen-locked interface; and in response to unlocking information input through an unlocking operation triggered on the screen-locked interface, cause the first operating system to perform the validity verification on the unlocking information.

In an embodiment, the verification module 1002 is further configured to, in response to a trigger operation performed on the screen-locked interface, cause the first operating system to display an unlock interface, where an unlocking information input window is displayed in the unlock interface; and cause the first operating system to obtain the unlocking information input in the unlocking information input window and perform the validity verification on the unlocking information.

In an embodiment, the verification module 1002 is further configured to: cause the second operating system to perform validity verification on the unlocking information; and when the validity verification performed on the unlocking information by the second operating system is passed, cause the second operating system to perform the correctness verification on the unlocking information.

In an embodiment, the second operating system has a trusted execution environment. The verification module 1002 is further configured to cause the second operating system to perform the correctness verification on the unlocking information in the trusted execution environment, when the validity verification performed on the unlocking information by the second operating system is passed.

In an embodiment, the sending module 1004 is further configured to, after the correctness verification performed on the unlocking information by the second operating system is passed, send a result indicating that the correctness verification is passed to the first operating system. The unlocking module 1006 is further configured to cause the first operating system to unlock the screen of the electronic device, in response to the result indicating that the correctness verification is passed.

In an embodiment, the sending module 1004 is further configured to: after the correctness verification performed on the unlocking information by the second operating system is passed, encrypt the result indicating that the correctness verification is passed, and send the encrypted result indicating that the correctness verification is passed to the first operating system. The unlocking module 1006 is further configured to cause the first operating system to decrypt the encrypted result indicating that the correctness verification is passed, and unlock the screen of the electronic device in response to obtaining, through the decrypting, the result indicating that the correctness verification is passed.

In an embodiment, the above apparatus further includes a control module. The control module is configured to, in a case where the screen is controlled by the second operating system, cause the first operating system to control the screen in response to the screen being turned off; and cause the first operating system to control the screen to enter a screen-locked state, in response to determining that the screen meets a screen-locking condition.

Each module in the above screen unlocking apparatus may be fully or partially implemented by software, hardware, or a combination thereof. The above modules may be embedded in or independent of the processor of the electronic device in the form of hardware, or stored in the memory of the electronic device in the form of software, so that the processor may call and execute the operations corresponding to the above modules.

In an embodiment, an electronic device is provided. The electronic device may be a terminal, and its internal structure may be as illustrated in FIG. 11. The electronic device includes a processor, a memory, an input/output interface, a communication interface, a display unit, and an input means. The processor, the memory, and the input/output interface are connected through a system bus. The communication interface, the display unit, and the input means are connected to the system bus through the input/output interface. The processor of the electronic device is configured to provide computing and control capabilities. The memory of the electronic device includes a non-volatile storage medium and an internal memory. The non-volatile storage medium stores an operating system and a computer program. The internal memory provides an environment for the operation of the operating system and the computer program in the non-volatile storage medium. The input/output interface of the electronic device is used for information exchange between the processor and external devices. The communication interface of the electronic device is used for communicating with an external terminal in a wired or wireless manner. The wireless manner may be implemented through WIFI, mobile cellular network, Near Field Communication (NFC), or other technologies. The computer program, when being executed by the processor, causes the screen unlocking method(s) to be implemented. The display unit of the electronic device is configured to display a visually visible image, which may be a display screen, a projection device, or a virtual reality imaging device. The display screen may be a liquid crystal display screen or an electronic ink display screen. The input means of the electronic device may be a touch layer covered on the display screen, or a button, a trackball, or a touch pad arranged on the shell of the electronic device, or an external keyboard, touch pad, or mouse.

Those skilled in the art may understand that the structure illustrated in FIG. 11 is only a part of the structure related to the solution of the present disclosure, and it does not constitute a limitation on the electronic device to which the solution of the present disclosure is applied. The specific electronic device may include more or fewer components than those shown in the figure, or combine some components, or have different component arrangements.

The embodiments of the present disclosure further provide a computer-readable storage medium. For example, one or more non-volatile/non-transitory computer-readable storage media containing computer-executable instructions are provided. When the computer-executable instructions are executed by one or more processors, the one or more processors are caused to perform the operations of the screen unlocking method(s).

The embodiments of the present disclosure further provide a computer program product containing instructions. When the instructions run on a computer, the computer is caused to execute the screen unlocking method(s).

It is notable that the user information (including but not limited to user device information, user personal information, etc.) and data (including but not limited to data used for analysis, stored data, displayed data, etc.) involved in the present disclosure are all information and data authorized by the user or fully authorized by all parties. The collection, use, and processing of relevant data need to comply with the relevant laws and regulations and standards of relevant countries and regions.

Those of ordinary skill in the art may understand that all or part of the processes in the methods of the above embodiments may be implemented by instructing relevant hardware through a computer program. The computer program may be stored in a non-volatile/non-transitory computer-readable storage medium. When the computer program is executed, it may implement the processes of the above method embodiments. The memory, database, or other media involved in the present disclosure may include at least one of non-volatile memory and volatile memory. The non-volatile memory may include Read-Only Memory (ROM), magnetic tape, floppy disk, flash memory, optical memory, high-density embedded non-volatile memory, Resistive Random Access Memory (ReRAM), Magnetoresistive Random Access Memory (MRAM), Ferroelectric Random Access Memory (FRAM), Phase Change Memory (PCM), graphene memory, etc. The volatile memory may include Random Access Memory (RAM) or external cache memory, etc. By way of illustration and not limitation, the RAM may be in various forms, such as Static Random Access Memory (SRAM) or Dynamic Random Access Memory (DRAM). The database involved in the embodiments of the present disclosure may include at least one of a relational database and a non-relational database. The non-relational database may include a distributed database based on a blockchain, etc., which is not limited herein. The processor involved in the embodiments of the present disclosure may be a general-purpose processor, a central processing unit, a graphics processor, a digital signal processor, a programmable logic device, a data processing logic device based on quantum computing, etc., which is not limited herein.

The technical features of the above embodiments can be combined arbitrarily. To make the description concise, not all possible combinations of the technical features in the above embodiments are described. However, as long as there is no contradiction in the combination of these technical features, they should be considered as falling within the scope of the disclosure.

The above embodiments only illustrate several implementations of the present disclosure, and their descriptions are specific and detailed, but they cannot be understood as limitations on the scope of protection of the present disclosure. It is notable that, for those of ordinary skill in the art, several modifications and improvements can be made without departing from the concept of the present disclosure, and all of which fall within the scope of protection of the present disclosure. Therefore, the scope of protection of the present disclosure should be subject to the appended claims.

1. A screen unlocking method, implemented by an electronic device, wherein the electronic device is capable of running a first operating system and a second operating system and the method comprises:
in a case where the electronic device is in a screen-locked state, in response to unlocking information input through an unlocking operation, performing, by the first operating system, validity verification on the unlocking information;
after determining that the validity verification performed on the unlocking information by the first operating system is passed, sending, by the first operating system, the unlocking information to the second operating system; and
after correctness verification performed on the unlocking information by the second operating system is passed, unlocking a screen of the electronic device.

2. The method of claim 1, wherein the performing, by the first operating system, the validity verification on the unlocking information in response to the unlocking information input through the unlocking operation, in the case where the electronic device is in the screen-locked state, comprises:
in the case where the electronic device is in the screen-locked state, displaying, by the first operating system, a screen-locked interface; and
in response to unlocking information input through an unlocking operation triggered on the screen-locked interface, performing, by the first operating system, the validity verification on the unlocking information.

3. The method of claim 2, wherein the performing, by the first operating system, the validity verification on the unlocking information in response to the unlocking information input through the unlocking operation triggered on the screen-locked interface, comprises:
in response to a trigger operation performed on the screen-locked interface, displaying, by the first operating system, an unlock interface, wherein an unlocking information input window is displayed in the unlock interface; and
obtaining, by the first operating system, unlocking information input in the unlocking information input window, and performing, by the first operating system, the validity verification on the unlocking information.

4. The method of claim 1, further comprising:
performing, by the second operating system, validity verification on the unlocking information; and
after determining that the validity verification performed on the unlocking information by the second operating system is passed, performing, by the second operating system, the correctness verification on the unlocking information.

5. The method of claim 4, wherein the second operating system has a trusted execution environment, and the performing, by the second operating system, the correctness verification on the unlocking information after determining that the validity verification performed on the unlocking information by the second operating system is passed, comprises:
after determining that the validity verification performed on the unlocking information by the second operating system is passed, performing, by the second operating system, the correctness verification on the unlocking information in the trusted execution environment.

6. The method of claim 1, wherein the unlocking the screen of the electronic device after the correctness verification performed on the unlocking information by the second operating system is passed, comprises:
after the correctness verification performed on the unlocking information by the second operating system is passed, sending, by the second operating system, to the first operating system a result indicating that the correctness verification is passed; and
unlocking, by the first operating system, the screen of the electronic device after receiving the result indicating that the correctness verification is passed.

7. The method of claim 6, wherein the sending, by the second operating system, to the first operating system the result indicating that the correctness verification is passed, after the correctness verification performed on the unlocking information by the second operating system is passed, comprises:
after the correctness verification performed on the unlocking information by the second operating system is passed, encrypting, by the second operating system, the result indicating that the correctness verification is passed, and sending, to the first operating system, an encrypted result indicating that the correctness verification is passed; and
the unlocking, by the first operating system, the screen of the electronic device after receiving the result indicating that the correctness verification is passed, comprises:
decrypting, by the first operating system, the encrypted result indicating that the correctness verification is passed, and unlocking, by the first operating system, the screen of the electronic device after obtaining, through the decrypting, the result indicating that the correctness verification is passed.

8. The method of claim 1, further comprising:
in a case where the screen is controlled by the second operating system, determining that the screen is turned off, and controlling, by the first operating system, the screen in an off state; and
upon determining that that the screen meets a screen-locking condition, controlling, by the first operating system, the screen to enter the screen-locked state.

9.-16. (canceled)

17. An electronic device, comprising a memory and one or more processors, wherein the electronic device is capable of running at least a first operating system and a second operating system, the memory stores therein a computer program which, when being executed by the one or more processors, causes the one or more processors to:
in a case where the electronic device is in a screen-locked state, when receiving unlocking information input through an unlocking operation, perform, by the first operating system, validity verification on the unlocking information;
after determining that the validity verification performed by the first operating system on the unlocking information is passed, send, by the first operating system, the unlocking information to the second operating system; and
after correctness verification performed on the unlocking information by the second operating system is passed, unlock a screen of the electronic device.

18. A non-transitory computer-readable storage medium storing a computer program thereon, wherein the computer program is executable by one or more processors of an electronic device, the electronic device is capable of running at least a first operating system and a second operating system; the computer program, when being executed by the one or more processors, causes following operations to be implemented:
in a case where the electronic device is in a screen-locked state, after receiving unlocking information input through an unlocking operation, performing, by the first operating system, validity verification on the unlocking information;
after determining that the validity verification performed on the unlocking information by the first operating system is passed, sending, by the first operating system, the unlocking information to the second operating system; and
after correctness verification performed on the unlocking information by the second operating system is passed, unlocking a screen of the electronic device.

19. (canceled)

20. The method of claim 1, further comprising:
receiving, by the second operating system, the unlocking information; and
performing, by the second operating system, directly the correctness verification on the received unlocking information.

21. The method of claim 1, wherein the electronic device comprises a first processor and a second processor, the first processor is configured to run the first operating system, the second processor is configured to run the second operating system, and power consumption of the first operating system is lower than power consumption of the second operating system.

22. The method of claim 1, wherein the performing, by the first operating system, the validity verification on the unlocking information, comprises:
in a case where the unlocking information is one of biological information, a slide pattern, or string information of a preset length, determining that the validity verification performed by the first operating system on the unlocking information is passed;
in a case where the unlocking information is not one of biological information, a slide pattern, or string information of a preset length, determining that the validity verification performed by the first operating system on the unlocking information is failed.

23. The method of claim 1, wherein the sending, by the first operating system, the unlocking information to the second operating system comprises:
obtaining, through the first operating system, encrypted unlocking information by encrypting the unlocking information with a target key, and sending, by the first operating system, the encrypted unlocking information to the second operating system; and
the method further comprises:
obtaining, by the second operating system, the unlocking information through decrypting the encrypted unlocking information with the target key;
wherein the target key is obtained through negotiation between the first operating system and the second operating system.

24. The electronic device of claim 17, wherein power consumption of the first operating system is lower than power consumption of the second operating system, and the computer program, when being executed by the one or more processors, further causes the one or more processors to:
in the case where the electronic device is in the screen-locked state, display, by the first operating system, a screen-locked interface;
in response to a trigger operation performed on the screen-locked interface, display, by the first operating system, an unlock interface, wherein an unlocking information input window is displayed in the unlock interface; and
obtain, by the first operating system, unlocking information input in the unlocking information input window, and perform, by the first operating system, the validity verification on the unlocking information.

25. The electronic device of claim 17, wherein the computer program, when being executed by the one or more processors, further causes the one or more processors to:
perform, by the second operating system, validity verification on the unlocking information; and
when the validity verification performed on the unlocking information by the second operating system is passed, perform, by the second operating system, the correctness verification on the unlocking information.

26. The electronic device of claim 25, wherein the computer program, when being executed by the one or more processors, further causes the one or more processors to:
perform, by the second operating system, the correctness verification on the unlocking information in a trusted execution environment.

27. The electronic device of claim 17, wherein the computer program, when being executed by the one or more processors, further causes the one or more processors to:
after the correctness verification performed on the unlocking information by the second operating system is passed, send, by the second operating system, to the first operating system a result indicating that the correctness verification is passed; and
unlock, by the first operating system, the screen of the electronic device, upon receiving the result indicating that the correctness verification is passed.

28. The electronic device of claim 27, wherein the computer program, when being executed by the one or more processors, further causes the one or more processors to:
after the correctness verification performed on the unlocking information by the second operating system is passed, encrypt, by the second operating system, the result indicating that the correctness verification is passed, and send, to the first operating system, an encrypted result indicating that the correctness verification is passed; and
decrypt, by the first operating system, the encrypted result indicating that the correctness verification is passed, and unlock, by the first operating system, the screen of the electronic device upon obtaining, through the decrypting, the result indicating that the correctness verification is passed.

29. The electronic device of claim 17, wherein the computer program, when being executed by the one or more processors, further causes the one or more processors to:
in a case where the screen is controlled by the second operating system, when the screen is turned off, control, by the first operating system, the screen in an off state; and
upon determining that that the screen meets a screen-locking condition, control, by the first operating system, the screen to enter the screen-locked state.
